(19) United States
(12) Patent Application Publication
(10) Pub. No.: US 2006/0020791 A1
(43) Pub. Date: Jan. 26, 2006

(54) Entity for use in a generic authentication architecture

(76) Inventor: Pekka Laitinen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/895,995

(22) Filed: Jul. 22, 2004

(51) Int. Cl. H04L 9/00

(52) U.S. Cl. 713/168

(57) ABSTRACT

An entity uses generic authentication architecture and Liberty architecture. The entity provides both a Liberty enabled proxy function and a network application function.

### FIELD OF THE INVENTION

The present invention relates to an entity for use in a Generic Authentication Architecture and a method of authenticating user equipment.

### BACKGROUND OF THE INVENTION

The current development towards truly mobile computing and networking has brought on the evolution of various access technologies, which also provide the users with access to the Internet when they are outside their own home network.

So far, the use of the Internet has been dominated by person-to-machine communications, i.e. information services. The evolution towards the so called third generation (3G) wireless networks brings along mobile multimedia communications, which will also change the way IP (Internet Protocol) based services are utilised in public mobile networks. The IP multimedia subsystem (IMS), as specified by the third generation partnership project (3GPP) integrates mobile voice communication with Internet technologies, allowing IP based multimedia services to be utilised in mobile networks.

The third Generation Partnership Project 3GPP has proposed a so called Generic Authentication Architecture GAA. This is for example described in the technical specification TS 33.220.

The Liberty Alliance is a consortium of a number of organisations and was set up to establish an open standard for federated network identity. More information about this organisation can be found on the web site www.projectliberty.org.

It has been proposed that the Liberty Alliance single sign-on proposal be used together with the GAA architecture. Single sign-on means that an end user is authenticated by the system only once, and is given access to one or more applications in that system.

Reference is made to FIG. 1 which schematically shows the Liberty Alliance single sign-on model. In this model, user equipment 2 is able to request a service from a service provider 6. The user equipment 2 is also connected to an identity provider IdP 4. In this procedure, the IdP 4 effectively authorises the user equipment to the service provider. Messaging from the service provider SP to the IdP and vice versa passes by the user equipment. The messaging which passes may be in the form of XML (extended markup language) files. Page: 2 The UE may or may not be Liberty enabled. Liberty enabled means that the UE understands the XML messages coming from SP and IdP. In the case, where UE is not Liberty enabled, HTTP redirect messages are used (HTTP status code 302 and HTTP “Location” header; see IETF (Internet Engineering Task Force document RFC 2616).

A HTTP redirect method can be used by web servers to “redirect” the browser to a new web address (i.e., URL) without the end user “clicking” a link.

FIG. 2 illustrates a scenario where the user equipment 2 is not a Liberty enabled client. In order to permit the user equipment to the nevertheless be used with Liberty based entities, a Liberty enabled proxy LEP 8 is provided to which the user equipment 2, the IdP 4 and the service provider are all connected. Using this arrangement, the user equipment is authenticated to the service provider 6. Messaging between the IdP 4 and the service provider 6 passes through the Liberty enabled proxy 8. The files will be in the form of XML messages.

Reference will now be made to FIG. 6 which shows the signal flow when the Liberty Alliance architecture inter works with the GAA architecture. The user equipment is not Liberty enabled. The message protocol used is HTTP (Hyper Text Transfer Protocol) Digest authentication which is discussed for example in the IETF Internet Engineering Task Force specifications RFC 2617. It is also discussed in 3GPP specifications TS 33.222 and TS 24.109.

In the signalling arrangement shown in FIG. 6, the IdP of FIG. 1 is combined with a NAF (network application function). The NAF function is required by the GAA architecture. The NAF is an application server that authenticates clients for example UE using GAA. The bootstrapping server function BSF which is also required by the GAA architecture is also shown.

In step A1, the user equipment 2 sends to the service provider a GET/HTTP/1.1 message. 1.1 refer to the version of HTTP. The GET message is used to initiate a service procedure and effective is a request for a service from the service provider.

In step A2, the service provider 6 replies with a HTTP/1.1 302 message to the user equipment which includes the IdP address along with a authentication request. A 302 message effectively indicates that requested resource, that is the service provider, has been found but that a temporary redirection is required, in this case to the IdP. This is for the purposes of authentication.

In step A3, the user equipment sends a GET <IdP address><authentication request> HTTP 1.1 message to the IdP-NAF combined functionality 5. The IdP functionality is for the Liberty Alliance architecture and the NAF network application function is for the GAA architecture. The purpose of this message is to ask the IdP to carry out the authentication for the service provider, hence the inclusion of the authentication request from the service provider in the message.

In step A4, the IDP-NAF function 5 replies with an HTTP/1.1 401 unauthorised message which indicates that the user equipment should authenticate itself using the bootstrapping function 8 and provides the address of the bootstrapping server function.

In step A5, the bootstrapping procedure is carried out to thereby authenticate the user equipment.

In step A6, a GET/HTTP/1.1 message is sent from the user equipment to the IdP-NAF combined functionality 5 including the transaction identifier TID and a digest that has be computed using a password. The password used is a secret key Ks_naf.

In step A7, a request is sent from the IdP-NAF 5 to the bootstrapping server function 8 requesting the secret key Ks_naf using the transaction identifier. This is done using the DIAMETER protocol.

In step A8, the bootstrapping server function 8 returns the secret key Ks_naf and optionally the NAF specific profile data. This is in a DIAMETER message. Using the information provided by the user equipment in step A6 and by the bootstrapping server function, the IdP-NAF combined functionality is arranged to authenticate the user.

In step A9, a HTTP/1.1 302 message is sent from the IdP-NAF to the user equipment. This message includes the service provider address and the authentication response, that is that the user equipment is authenticated.

In step A10, the user equipment sends an authentication response to the service provider 6, including the authentication response. This is so the service provider knows that the user equipment is authenticated.

In step A11, a HTTP/1.1 200 OK (GET) message is sent from the service provider to the user equipment. This will include the service requested by the user equipment.

In steps A4 to A8 the IdP authenticates the UE using GAA. The UE is not Liberty enabled.

However, this arrangement has the problem that the IdP must be combined with a NAF. This may not always possible particularly if for example the Liberty infrastructure is already in place.

Another problem with the known architecture occurs when a Liberty enabled proxy is required which is part of the Liberty architecture, and when the IdP is combined with a NAF.

### SUMMARY OF THE INVENTION

In a first aspect, the present invention provides an entity for use with generic authentication architecture and Liberty architecture, said entity providing both a Liberty enabled proxy function and a network application function.

According to another aspect of the present invention there is provided a method of authentication user equipment comprising the step of: using an entity which provides a Liberty enabled proxy function and a network application function to authenticate said user equipment.

### BRIEF DESCRIPTION OF DRAWINGS

For a better understanding of the present invention and as to how the same may be carried into effect, reference will now be made by way of example to the accompanying drawings in which:

FIG. 1 shows a schematical view of a known arrangement in which user equipment is authenticated using Liberty;

FIG. 2 illustrates schematically user equipment which is not Liberty enabled but uses a Liberty enabled proxy;

FIG. 3 shows schematically an embodiment of the present invention;

FIG. 4 shows the signal flow in an embodiment of the present invention;

FIG. 5 shows the bootstrapping procedure of FIG. 4 in more detail; and

FIG. 6 shows a signal flow in a known arrangement where GAA-based authentication is used.

### DETAILED DESCRIPTION OF PREFERRED EMBODIMENTS OF THE PRESENT INVENTION

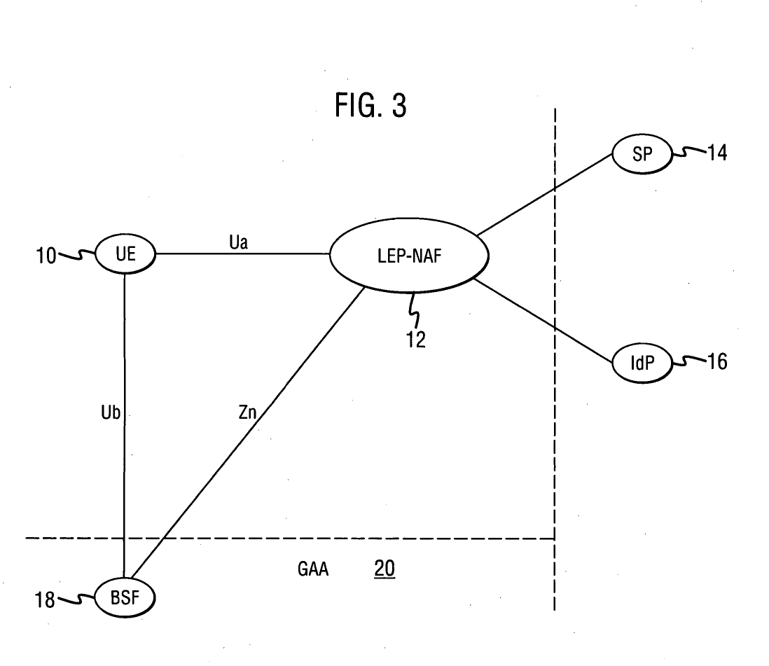

Reference is made to FIG. 3 which schematically shows an environment in which the embodiment of the present invention can be incorporated.

User equipment 10 is provided. The user equipment can take any suitable format and may for example be a mobile telephone, portable computer, personal organiser, mobile station or any other suitable entity. In preferred embodiments of the present invention the user equipment is mobile and not fixed. The user equipment is arranged to communicate with a suitable entity such as a base station via a wireless connection. Entities including the base station and other radio access network entities have been omitted for clarity.

The user equipment can communicate with an entity 12 which combines the functionality of a Liberty enabled proxy LEP and a network application function NAF. The LEP-NAF authenticates the user equipment using GAA. The LEP handles Liberty based messaging on behalf of the non Liberty enabled terminals. It is typically part of the WAP (wireless application protocol). The authentication procedure between the user equipment and the LEP-NAF is based on the Ua interface that is the HTTP digest.

The entity 12 is arranged to communicate with a service provider 14. The entity 12 is also arranged to communicate with an identity provider IdP 16.

The user equipment 10 is also arranged to communicate with a bootstrapping server function BSF 18 of the GAA architecture. This is via the Ub interface. The entity 12 is also arranged to communicate with the bootstrapping server function 16, this being via the Zn interface.

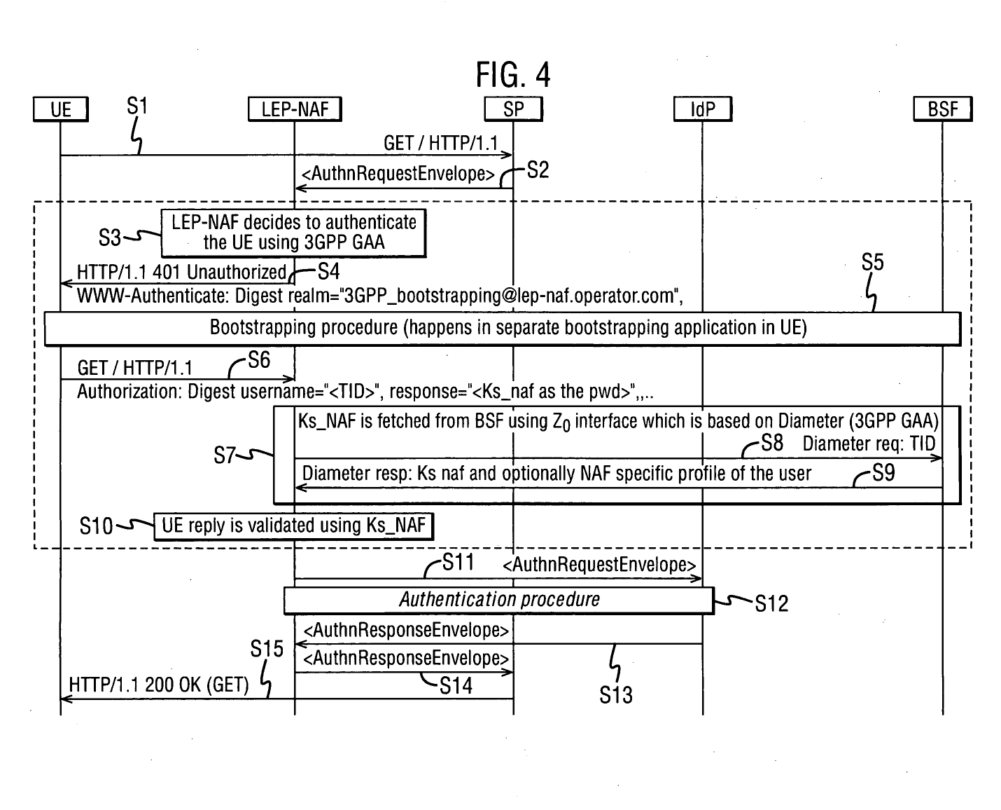

The signalling flow in the arrangement shown in FIG. 3 will now be prescribed in relation to FIG. 4 which shows the signal flow in an embodiment of the present invention. The entities shown in FIG. 3 are the same as those shown in FIG. 4 and accordingly common reference numerals are used.

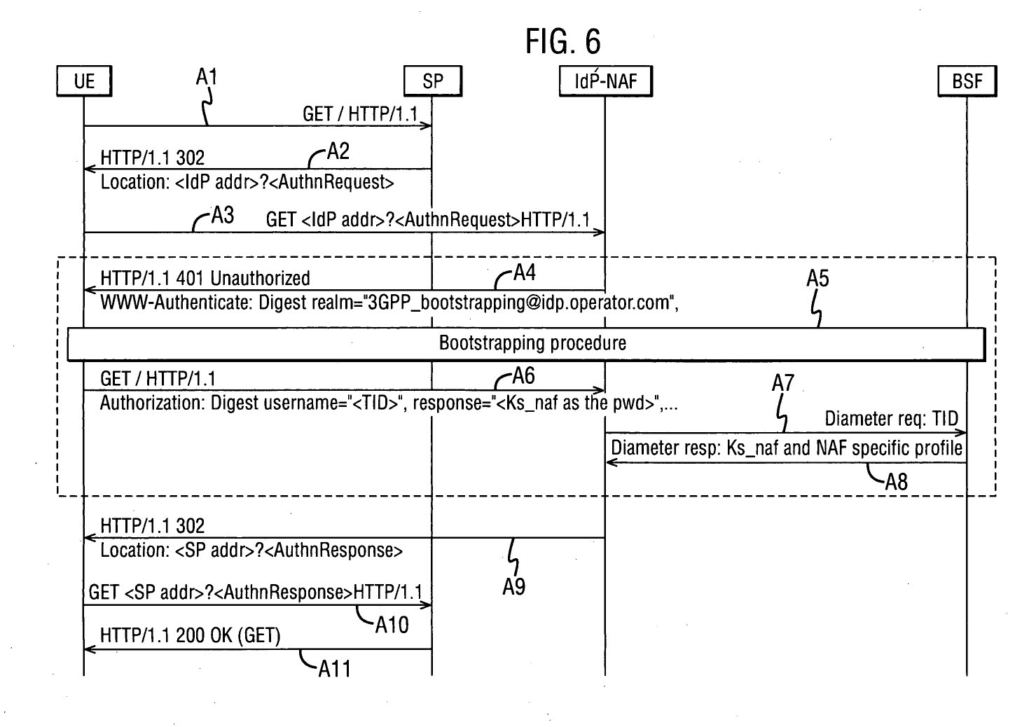

In step S1, the user equipment sends a request for a service through the entity 12 to a service provider in form of a GET/HTTP/1.1 message. This is similar to step A1 of FIG. 6.

In step S2, the service provider 14 sends an authentication request envelope to the entity 12 requesting authentication of the user equipment. This is in accordance with the Liberty Alliance standards and so may be in the form of an XML.

In step S3, the entity 12 decides to authenticate the user equipment 10 using 3GPP GAA.

In step S4, the entity 12 sends a message to the user equipment 10. The message sent in step S4 is a HTTP/1.1 401 unauthorised message. This is similar to the message sent in step A4 of FIG. 6 but is instead sent by the entity 12 of the arrangement of FIG. 3.

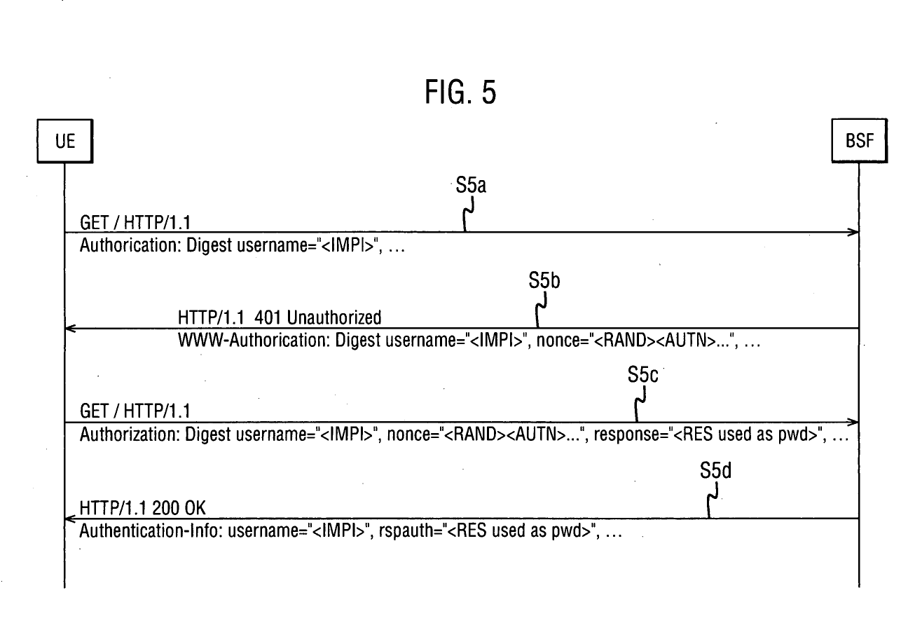

In step S5, the bootstrapping procedure occurs and the user equipment is authenticated. The bootstrapping procedure of step S5 will be described in more detail later with reference to FIG. 5.

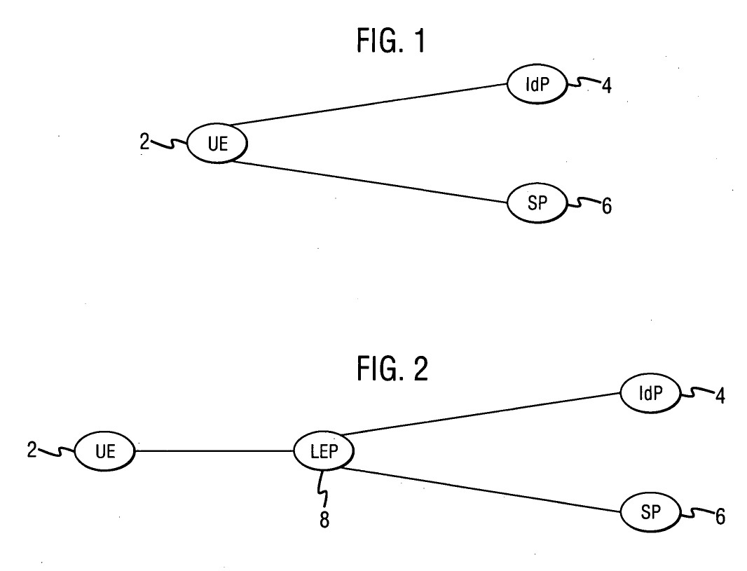

In step S6, the user equipment 10 will send a message to the entity 12 providing the transaction identifier TID and an digest response that has been computed using an authentication key as the password. This is a GET/HTTP/1.1 message and is similar to that sent in step A6 of FIG. 1 but is instead sent to the entity 12.

In step S7, the entity 12 fetches the secret key from the bootstrapping server function 18 using the Zn interface. More particular, in step S8, the entity 12 sends the transaction identifier in a DIAMETER request to the bootstrapping function 18. The bootstrapping function replies in step S9 with the secret key Ks_naf and optionally the network application function NAF specific profile of the user.

In step S10, the information received by the entity 12 from the user equipment i.e. the digest response is validated using the secret key Ks_naf requested from the bootstrapping server function.

In step S11, the authorisation request envelope is sent from the entity 12 to the IdP 16. This is the envelope received in step S2. This is a Liberty alliance message so will be in the form of an XML file.

In step 12, the IdP 16 authenticates the entity 12. During this step the entity 12 communicates the identity of the UE to the IdP. The exact details of this authentication are known and will not be discussed in detail, but there are two general ways to accomplish this. The IdP may think that is communicating directly with the user equipment 10. In this case, the entity 12 pretends to be the user equipment to the IdP 16 and it is in possession of necessary credentials to authenticate itself towards the IdP as the user equipment. For example, it may possess a login/password pair belong to the user equipment. The IdP may also know that is communicating with the entity 12. In this case, the IdP first authenticates the entity 12 itself. After the entity 12 has been authenticated, it can communicate the identity of the user equipment 10 to the IdP 16.

In step S13, the authentication response envelope is sent from the IdP 16 to the entity 12. The authentication response envelope contains the user identity of the user equipment 10 that is known by the service provider 14. This is in accordance with the Liberty Alliance standards and so may be in the form of an XML.

In step S14, the authentication response envelope is sent by the entity 12 to the service provider 14. In other words, the user equipment has now been authenticated for the service provider.

In step S15, the service provider 14 provides a message HTTP/1.1 200 OK (GET) which include the service requested by the user.

Thus in steps S3 to S10, the user equipment is authenticated by LEP-NAF using GAA. The IdP is not involved. In step S12, the IdP authenticates LEP-NAF and the LEP-NAF “tells” the IdP who the user equipment is.

It should be appreciated that the same GAA authentication of a given user equipment can be used multiple times in the entity 12 provided that the bootstrapping key life time is still valid.

It should be appreciated that the signalling of steps S3 to S10 may take place for example before step S1 and S2.

Reference will now be made to FIG. 5 which shows the bootstrapping procedure of step S5 of FIG. 4 in more detail.

In step S5a, the user equipment sends a GET/HTTP/1.1 message to the boot strapping function requesting authentication and including the IMS private identity IMPI of the user equipment.

In step S5b, the bootstrapping function replies with an HTTP/1.1 401 unauthorised message. This is an authentication challenge. This includes the IMPI of the user equipment and a nonce containing at least RAND and AUTN which are used in the authentication procedure. The information received by the user equipment is used to formulate a response to the bootstrapping function. The method of authorisation is well known and is not discussed in detail.

The response formulated by the user equipment is sent in step S5c is sent to the bootstrapping server function. The response is a response to the authentication challenge of step 5b. This reply includes IMPI, the authentication variables RAND, AUTN etc and a response generated from the result which is computed using a password. The message sent is a GET/HTTP/1.1 message.

In step S5d the bootstrapping server function, after authenticating the user sends a HTTP1.1 200 OK message including the IMPI, a transaction identifier TID, and possibly some other data. This indicates that the bootstrapping procedure has been successful.

The steps shown in FIG. 5 are used thus to authenticate the user. This is defined in the 3GPP specification TS 33.220. It should be appreciated that the transaction identifier is used to identify the bootstrapping session. The key material Ks, for example discussed in relation to steps S6 and S9 are used to generate network application function specific keys KS_nafs.

The key material lifetime defines how long the key material can be used.

The KS_naf and TID can be used in the Ua interface to mutually authenticate the user equipment and the entity 12 and optionally secure the traffic between the user equipment and the entity 12.

In the embodiment described in relation to FIG. 4, the user equipment is not a Liberty enabled client. However, the Liberty protocols are desired to be used. Accordingly, the Liberty enabled proxy is combined with the network application function. The Liberty enabled proxy allows the clients i.e. user equipment that are not Liberty enabled to be used in a Liberty enabled environment.

The combined Liberty enabled proxy and network application function is able to handle the Liberty communication and authentication on behalf of the client. The NAF part authenticates the user based on the bootstrapping procedure that is carried out between the client and the bootstrapping server function. The combined entity authenticates the client using GAA and provides authentication information to the IdP.

The IdP and the service providers do not need to know about GAA. The signalling between the LEP and service provider is purely Liberty signalling.

The User equipment needs to explicitly trust the LEP. The IdP needs to trust the LEP if it is going to give a higher grade for the authentication method.

The connection UE to LEP-NAF entity is secured. For example both the entities maybe in a trusted domain, ie the operators network of the both entities may use TLS (transport layer security) to secure communication.

1. An entity for use with generic authentication architecture and Liberty architecture, wherein said entity provides a Liberty enabled proxy function and a network application function.

2. An entity as claimed in claim 1, wherein said entity is configured to authenticate user equipment using the generic authentication architecture.

3. An entity as claimed in claim 2, wherein said entity is configured to send a message to said user equipment indicating that said user equipment is to authenticate with said generic authentication architecture.

4. An entity as claimed in claim 3, wherein said entity is configured to send the message to said user equipment indicating that said user equipment is to authenticate with a bootstrapping server function of said generic authentication architecture.

5. An entity as claimed in claim 2, wherein said entity is configured to receive authentication information from said user equipment.

6. An entity as claimed in claim 5, wherein said authentication information comprises at least one of a transaction identifier and a secret key.

7. An entity as claimed in claim 5, wherein said entity is configured to obtain said authentication information from said generic authentication architecture.

8. An entity as claimed in claim 7, wherein said entity is configured to authenticate said user equipment according to the authentication information received from the user equipment and from the generic authentication architecture.

9. An entity as claimed in claim 1, wherein said entity is configured to send a message to an identity provider requesting authentication.

10. An entity as claimed in claim 9, wherein said entity is configured to send an authentication response from the identity provider to the service provider.

11. A system comprising:
an entity to use with generic authentication architecture and Liberty architecture, wherein said entity provides a Liberty enabled proxy function and a network application function;
an identity provider; and
a bootstrapping server function.

12. A system as claimed in claim 11, wherein said entity is connected to said bootstrapping server function.

13. A system as claimed in claim 11, wherein said identity provider is connected to said entity.

14. A system as claimed in claim 11, further comprising a service provider.

15. A system as claimed in claim 11, further comprising user equipment.

16. A system as claimed in claim 1, wherein a plurality of messages are sent therein, said plurality of messages being at least one of HTTP digest messages, XML files, SOAP message, and DIAMETER messages.

17. A method of authentication user equipment comprising the step of:
using an entity which provides a Liberty enabled proxy function and a network application function to authenticate said user equipment.

18. A method as claimed in claim 17, wherein said using step comprises using GAA to authenticate the user equipment.

19. A method as claimed in claim 17, comprising the step of sending a message to said user equipment from said entity indicating that said user equipment is to authenticate with said generic authentication architecture.

20. A method as claimed in claim 17, comprising the step of sending from said entity, a message to said user equipment indicating that said user equipment is to authenticate with a bootstrapping server function of said generic authentication architecture.

21. A method as claimed in claim 17, comprising the step of sending authentication information from said user equipment to said entity.

22. A method as claimed in claim 21, comprising the step of obtaining said authentication information from said generic authentication architecture.

23. A method as claimed in claim 22, wherein said authenticating step comprises authenticating said user equipment according to the authentication information received from the user equipment and from the generic authentication architecture.

24. A method as claimed in claim 17, comprising the step of authenticating said entity.

25. A method as claimed in claim 24, wherein said authenticating step for authenticating said entity comprises the entity providing information to an identity provider indicating the identity of said user equipment.

26. An entity for use with generic authentication architecture and Liberty architecture, said entity comprising:
enabling means for enabling a Liberty enabled proxy function; and
network application means for providing a network application function.
